(19) United States
(12) Patent Application Publication
(10) Pub. No.: US 2010/0014926 A1
(43) Pub. Date: Jan. 21, 2010

(54) System and Method for Pneumatically conveying Metered Amounts of Bulk Particulate Material

(76) Inventors: Anthony E. Boroch, Montoursville, PA (US); Steven S. Kelchner, Turbotville, PA (US); James E. Mothersbaugh, Muncy, PA (US); John W. Pfeiffer, Hughesville, PA (US)

Correspondence Address: Novak Druce & Quigg LLP, 1300 I Street NW, Suite 1000 West Tower, Washington, DC, 20005, US

(21) Appl. No.: 12/175,335

(22) Filed: Jul. 17, 2008

(51) Int. Cl. B65G 53/18; B65G 53/66

(52) U.S. Cl. 406/197; 406/89; 406/12

(57) ABSTRACT

A system for pneumatically conveying metered amounts of a bulk particulate material comprising a first conduit formed of a gas permeable material having a material inlet and outlet, a second conduit formed of a gas impermeable material encompassing and spaced from said first conduit, and means for intermittently supplying a fluidizing gas under pressure to the plenum between the first and second conduits.

This invention relates to the pneumatic conveying of bulk particulate materials and more particularly to a system and method of stabilized metering of such pneumatically conveyed material at low flow rates.

### BACKGROUND OF THE INVENTION

In the prior art, there has been developed a system and method for pneumatically conveying bulk particulate materials including cohesive and sluggish granular and powder materials which are illustrated and described in U.S. Pat. Nos. 6,179,500 and 6,764,253 assigned to The Young Industries, Inc., of Muncy, Pa., and are incorporated herein by reference. In the use of such systems to not only convey but meter the feed rate of such material, some adjustment of the feed rate has been found to be possible by controlling the flow rate of the gas supply. It further has been found that there is a minimum feed rate that can be achieved by controlling the flow rate of the gas. Decreasing the flow rate of the gas has been found to reach a point at which material flow will become erratic or even discontinued. Such lower limit point often is greater than the desired flow rate for accurate, consistent and reliable metering of material. Accordingly, it is the principle object of the present invention to provide a system and method of the type described which will accurately, consistently and reliably meter the feed rate of bulk particulate materials over a greater range of feed rate and particularly at a lower feed rate that is available in prior art systems and methods.

### SUMMARY OF THE INVENTION

The principal object of the present invention is achieved by providing a system for pneumatically conveying metered amounts of a bulk particulate material generally consisting of a first conduit formed of a permeable material having a material inlet and outlet, a second conduit formed of a gas impermeable material encompassing and spaced from the first conduit, and means for intermittently supplying a fluidizing gas under pressure to the plenum between the first and second conduits. Preferably, in such a system, the gas supply means is operable to supply gas for an interval in the range of 0.05 seconds to 10 seconds and then discontinue the supply of gas for an interval in the range of 0.05 seconds to 20 seconds per cycle. In another embodiment of the invention, a hopper is provided for feeding material into such first conduit, which hopper includes a first peripheral wall section formed of a gas permeable material, having an outlet communicating with the inlet of the first mentioned conduit for feeding a material therethrough and a second peripheral wall section spaced from an encompassing the first peripheral wall section formed of a gas impermeable material, to provide a peripheral chamber therebetween, and means for intermittingly supplying a fluidizing gas under pressure to such peripheral chamber. In such embodiment, the means for supplying gas to the peripheral chamber is operable to cycle differently from the cycle of the first mentioned means for supplying gas to the plenum between the first and second conduits.

### BRIEF DESCRIPTION OF THE DRAWINGS

FIG. 1 is a side elevational view of an embodiment of the invention; and

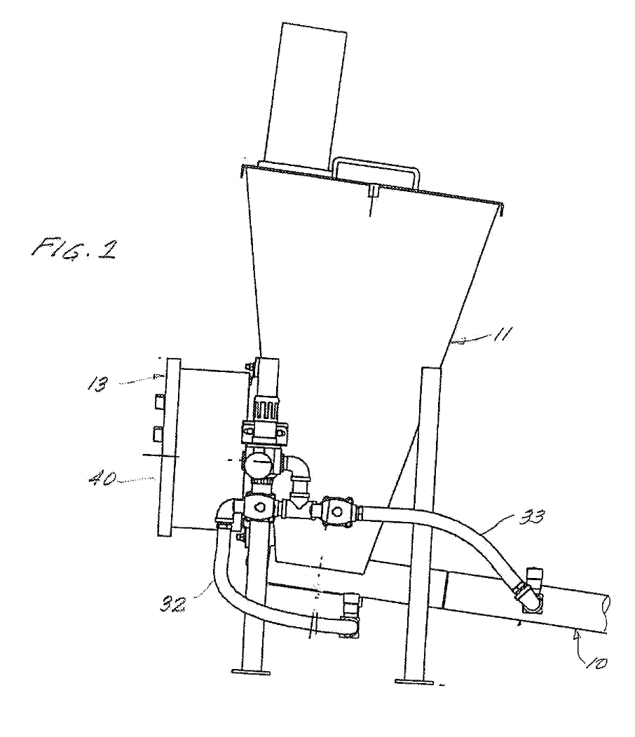

FIG. 2 is a schematic of the embodiment shown in FIG. 1.

### DETAILED DESCRIPTION OF THE PREFERRED EMBODIMENT

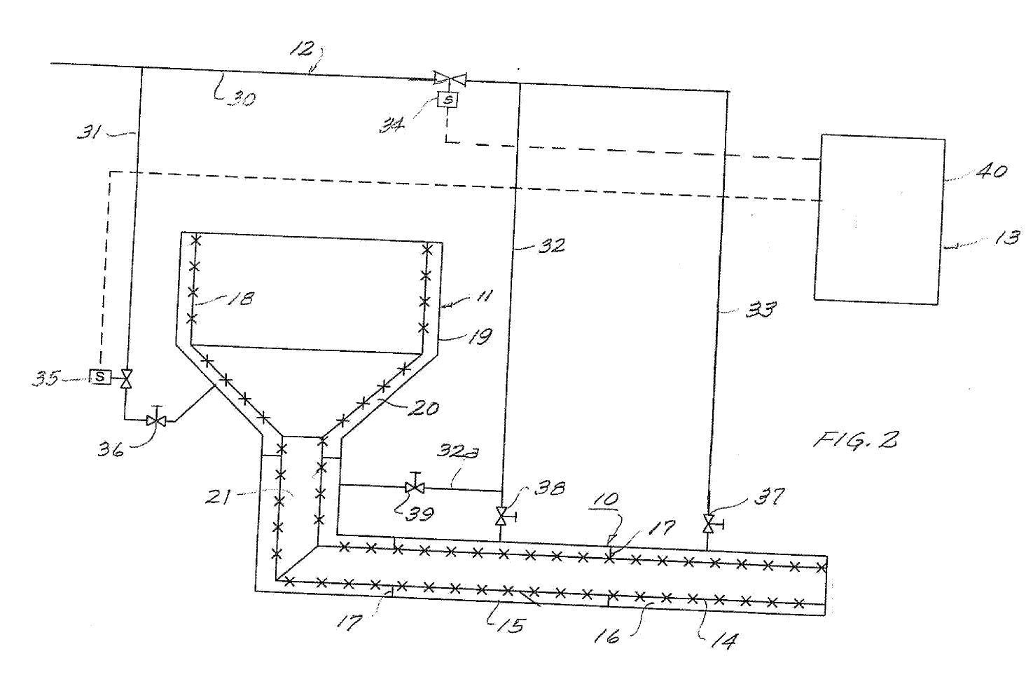

Referring to the drawings, there is illustrated a system for metering a bulk particulate material embodying the present invention which generally includes a material transport line 10, a material holding hopper 11 operatively connected to the transport line for gravity feeding material thereto, a gas supply system 12 connected to the transport line and hopper and a control system 13 operatively connected to the gas supply system. As best shown in FIG. 2, transport line 10 consists of a first, inner conduit 14 consisting of a gas permeable material and a second, outer conduit 15 formed of an impermeable material encompassing and spaced from inner conduit 14 to provide an annular chamber 16. As shown, annular chamber 16 may be provided with longitudinally spaced annular partitions 17 to further provide a plurality of annular chambers encompassing inner conduit 14. Hopper 11 includes an inner, peripheral section 18 formed of a gas permeable material and a spaced, outer wall section 19 spaced from and encompassing inner wall 18, formed of a gas impermeable material to provide a peripheral chamber 20. The lower end of the hopper is provided with a passageway 21 through which material in the hopper may be gravity fed into an inlet of inner conduit 14. To the extent that such passageway does not merely form an outlet communicating directly with an inlet of conduit 14, such passageway is defined by a similar inner conduit formed of a gas permeable material and an outer, spaced conduit encompassing such inner conduit and formed of a gas impermeable material to form an annular chamber therebetween as shown in FIG. 2.

Gas supply system 12 includes a main line 30 connected to a source of gas under pressure, a first branch line 31 interconnecting such main line and peripheral chamber 20 of the hopper, a second branch line 32 interconnecting main line 30 and annular chamber 15 and a branch line 33 interconnecting the main line and annular chamber 16. An additional branch line 32a interconnects branch line 32 and the annular chamber surrounding passageway 21. Disposed in main gas line 30 between its connections with branch lines 31 and 32 is an electrically actuated solenoid valve 34, and disposed in branch line 31 between the branch line and peripheral chamber 20 of the hopper is an electrically actuated solenoid valve 35. In addition, branch line 31 is provided with a manually operated valve 36, branch line 33 is provided with a manually operated valve 37, branch line 32 is provided with a manually operated valve 38 and branch 32a is provided with a manually operated valve 39. Such manually operated valves may be used to adjust the flow rate to the annular chambers when valves 34 and 35 are open.

Control system 13 essentially consists of a controller 40 operatively connected to electrically actuated solenoid valves 34 and 35. It may consists of an electromechanical, repeat-cycle time delayed relay, a programmable logic controller or a computer, operable or programmed to intermittently open and close solenoid valves 34 and 35 to permit a pulsating flow of gas under pressure to either or both of the annular or peripheral chambers of the transport line and/or hopper. In practice, it has been found that sequentially opening valve 34 for 0.05 to 10 seconds and closing such valve for an interval in the range of serial 0.05 seconds to 20 seconds is sufficient to provide a pulsating gas flow to the transport line to convey material at a low feed rate. It further has been found that to operate solenoid valve 36 to sequentially open for an interval in the range of 0.05 seconds to 10 seconds and close for an interval in the range of 0.05 seconds to 60 seconds per duty cycle, will enhance a steady and reliable feed rate of the material being dispensed.

In the use if the system as described, with valves 34 and 35 closed and controller 40 properly programmed, material to be metered is loaded in hopper 11 and controller 40 is operated to open valve 34. Under such conditions, a pulsating flow of fluidizing gas will be fed to the transport line to convey material gravity fed into the transport line from hopper 11 at a controlled flow rate. To enhance such flow rate controller 40 further may be operated to sequentially or concurrently open valve 35 to further assure a continuous and controlled flow rate of material from hopper 11 to conduit 10. The desired feed rate of the material being metered in the system may be adjusted simply by adjusting the duty cycle of the gas supplied to the transport line and the duty cycles of the gas supplied to both the hopper and the transport line.

The transport line may be positioned horizontally and may be disposed at a small downward angle to facilitate the flow of material. The gas pressure may be of any suitable amount although a pressure of 5 psig has been found to be suitable for most purposes.

Adjustment of fluidizing gas pulse length and frequency results in reliable and consistent flow of solids when the solenoid valve is turned on and consistent shutoff of solid flow when the solenoid valve is turned off. When operating in the pulse flow mode, it is neither necessary nor desirable to adjust the manual flow control valves away from their optimum settings for use in continuous-mode feeding and conveying. In pulse flow mode, feed rate is easily adjusted by changing the length of time the solenoid actuated compressed gas valve is on and the length of time it is off.

Experience with operating the system as described has shown that when handling certain particularly cohesive and sluggish powder materials, it is desirable also to provide a periodic, brief fluidizing gas pulse to the supply hopper above the inlet to the conveyor to ensure reliable flow of powder with the conveyor.

From the foregoing detailed description, it will be evident that there are a number of changes, adaptations and modifications of the present invention, which come within the province of those persons having ordinary skill in the art to which the aforementioned invention pertains. However, it is intended that all such variations not departing from the spirit of the invention be considered as within the scope thereof as limited solely by the appended claims.

What is claimed is:

1. A system for pneumatically conveying metered amounts of a bulk particulate material comprising;
a first conduit formed of a gas permeable material having a material inlet and outlet;
a second conduit formed of a gas impermeable material encompassing and spaced from said first conduit; and
means for intermittently supplying a fluidizing gas under pressure to the plenum between said first and second conduits.

2. A system according to claim 1 wherein said gas supplying means is operable to sequentially supply gas for an interval in the range of 0.05 seconds to 10 seconds and preclude the supply of gas for an interval in the range of 0.05 seconds to 20 seconds, per cycle.

3. A system according to claim 1 wherein the pressure of said gas is 5 psig.

4. A system according to claim 1 including partitions between said conduits providing a plurality of longitudinally disposed plenum chambers, and wherein said fluidizing gas is supplied selectively to one or more of said chambers.

5. A system according to claim 1 wherein said gas supplying means includes at least one conduit provided with an electrically actuated solenoid valve and one of an electromechanical repeat-cycle time delay relay, a programmable logic controller and a computer operatively connected to said valve.

6. A system according to claim 1 including means for injecting a gas under pressure into said first conduit.

7. A system according to claim 1 including a hopper for holding said material, including means for feeding said material into said inlet of said first conduit.

8. A system according to claim 7 wherein said hopper includes a first peripheral wall section formed of a gas permeable material, having an opening communicating with the inlet of said first conduit for feeding material therethrough, and a second peripheral wall section spaced from and encompassing said first peripheral wall section, formed of a gas impermeable material, to provide a peripheral chamber therebetween, and including means for intermittedly supplying a fluidizing gas under pressure to said peripheral chamber.

9. A system according to claim 8 wherein said means for supplying gas to said peripheral chamber is operable to cycle differently from the cycle of said first mentioned means for supplying gas to said plenum between said first and second conduit.

10. A system according to claim 9 wherein said second mentioned gas supplying means is operable to sequentially supply gas for an interval in the range of 0.05 seconds to 10 seconds and preclude the supply of gas for an interval in the range of 0.05 seconds to 60 seconds, per cycle.

11. A system according to claim 9 wherein said first mentioned gas supply means is operable to supply gas for an interval in the range of 0.05 seconds to 10 seconds and preclude the supply of gas for an interval in the range of 0.05 seconds to 20 seconds, per cycle, and said second mentioned gas supplying means is operable to supply gas for an interval in the range of 0.05 seconds to 10 seconds and preclude the supply of gas for an interval in the range of 0.05 seconds to 60 seconds, per cycle.

12. A system according to claim 8 wherein each of said fluidized gas supplying means includes at least one conduit provided with an electrically actuated solenoid valve and one of an electromechanical repeat-cycle relay, a programmable logic controller and a computer, operatively connected to said valve.

13. A system according to claim 8 including means for injecting a gas under pressure into said first conduit.

14. A system according to claim 1 wherein said first conduit is inclined relative to the horizontal.

15. A method of metering a bulk particulate material, comprising:
feeding said material into a conduit;
intermittedly supplying a fluidizing gas under pressure to said conduit to pneumatically convey said material.

16. A method according to claim 15 wherein said gas is supplied about a boundary of said material.

17. A method according to claim 15 wherein said gas is supplied in pulsating cycles consisting of an on interval in the range of 0.05 seconds to 10 seconds and an off interval in the range of 0.05 seconds to 20 seconds.

18. A method according to claim 15 wherein said gas is supplied at a pressure of 5 psig.

19. A method according to claim 15 including injecting a second stream of gas into said conduit.

20. A method according to claim 15 including feeding said material into said conduit from a hopper.

21. A method according to claim 20 including fluidizing said material in said hopper by supplying a gas under pressure about the peripheral of said hopper.

22. A method according to claim 21 including intermittedly supplying said gas to said conduit and said hopper in different interval cycles.

23. A method according to claim 21 including sequentially supplying gas to said conduit in cycles of an on interval in the range of 0.05 seconds to 10 seconds and an off interval in the range of 0.05 seconds to 20 seconds, and supplying gas to said hopper in cycles of an on interval in the range of 0.05 seconds to 10 seconds in an off interval in the range of 0.05 seconds to 60 seconds.
